(19) United States
(12) Patent Application Publication
(10) Pub. No.: US 2022/0390152 A1
(43) Pub. Date: Dec. 8, 2022

(54) Thermal Storage System for Buildings

(71) Applicant: Steven Bauman, Albuquerque, NM (US)

(72) Inventor: Steven Bauman, Albuquerque, NM (US)

(21) Appl. No.: 17/386,520

(22) Filed: Jul. 27, 2021

Related U.S. Application Data
(60) Provisional application No. 63/196,657, filed on Jun. 3, 2021.

(51) Int. Cl. F25B 29/00; F28F 1/24; F28F 1/10; F28F 9/013

(52) U.S. Cl. CPC F25B 29/00; F28F 1/24; F28F 1/105; F28F 9/0131; F28F 2210/10

(57) ABSTRACT

Apparatus related to thermal storage and exchange systems for use in buildings to selectively cool and/or heat a heat storage medium and cause said medium to reversibly pass between a liquid phase and a solid phase without requiring a complete discharge of a thermal reservoir between phase changes. In one embodiment, a cube filled with water and a gas or liquid within the horizontal tubing is used to charge the system, thereby freezing the water. The vertical tubing is then used to recover the energy by melting the ice, which is used for air conditioning. In one embodiment, copper tubing and fins are used to efficiently charge and discharge the system.

### BACKGROUND OF THE INVENTION

### 1. Field of the Invention

The present invention generally relates to on-site distributed demand thermal or heat storage and exchange systems that can be used in buildings. More particularly, the invention relates to a system, apparatus and/or process to selectively cool and/or heat a heat storage medium and cause said medium to pass reversibly between a liquid phase and a solid phase without requiring a complete discharge of a thermal reservoir between phase changes.

### 2. Description of Related Art

Thermal energy storage systems are a fast growing and evolving technology. Energy storage mechanisms that have been disclosed in the past include traditional electrical batteries, mechanical systems and phase-change material using common elements. Traditional and modern electrical batteries require perpetual maintenance and are short-lived due to constant deep cycling in addition to the costs of replacement cycles, particularly grid scale. At grid scale, energy release results in line congestion on transport lines at the time of demand. Phase-change materials on the other hand require extreme temperatures and therefore are not suitable except at remote facilities from major populations. Use of off-peak phase-change materials results in removal of line congestion on transport lines at the time of high demand.

Although there are continued efforts to improve traditional electrical battery technologies, their intrinsic high-cost nature limits their application to small scale emergency power supplies. In an effort to address these issues, several solutions have been introduced. One of which is U.S. Pat. No. 9,671,171, which discloses a system and method of thermal transfer and/or storage, or more particularly, a system for transferring/storing heat comprised of a heat exchange/storage apparatus including a chamber, a heat output device through which a working medium/fluid passes, a heat input device adapted to provide a vapor form of heat transfer fluid into the chamber, a thermal storage medium located within the chamber, and a heat exchange medium/fluid to the thermal storage surfaces.

Other relevant art includes U.S. Pub. No. 2005/0247906, U.S. Pat No. 10,900,667, and Applicant's prior work in this field, U.S. Pat. No. 5,944,089, the subject matter of which is incorporated herein by reference. However, none of these references teach or disclose features of the present invention that are discussed and claimed herein, resulting in an on-site distributed demand thermal or heat storage and exchange system having improved efficiency and operation. In particular, none of the references teach a simple, inexpensive, onsite-distributed demand thermal energy storage system with increased reliability, low cost of operation, and minimal maintenance cost. Hence, there remains a great social need for a system capable of removing transmission and discharge losses during peak demand times by storage of the energy on-site/behind the meter, during the line congestion, supplying required energy when and where required.

All the problems, disadvantages and the limitations of the above-mentioned relevant and conventional arts are being overcome by the method and composition of the present invention, which has various technical advancements and certain economic benefits over the conventional arts.

### SUMMARY OF THE INVENTION

The present invention provides a distributed demand thermal energy storage system with increased reliability, low cost of operation, and minimal maintenance cost. The system provided by the present invention removes transmission and discharge losses during peak demand times by storage of the energy on-site/behind the meter, during the line congestion, supplying required energy when and where required.

The objective of the present invention is to provide an improved thermal/heat storage system. More particularly, this invention relates to a system, apparatus and/or process that selectively cools and/or heats a heat storage medium and causes said medium to pass reversibly between a liquid phase and a solid phase without requiring a complete discharge of a thermal reservoir between phase changes.

The present invention discloses an apparatus generally comprising two intertwined heat exchangers. The two intertwined heat exchangers are placed within a housing or container. A surrounding fluid is then placed within the container. The surrounding fluid at least partially surrounds and contacts the first heat exchanger and the second heat exchanger. In a preferred embodiment, the first heat exchanger is used to make ice. The second heat exchanger is used to discharge or melt the ice. Both heat exchanger systems may be operated at the same time and/or at different rates to meet the load or demand placed upon the entire system.

In one embodiment, the present invention mainly pertains to a panel defined by each intertwined set of first and second heat exchangers. The present invention may be expanded or contracted for greater or lesser capacity by simply adding or removing additional interconnected panels from the system, as well as increasing or decreasing the phase change fluid in the container. Consequently, a system can be custom designed for a particular thermal load. Since each heat exchanger panel is relatively flat, a plurality of panels can be placed within a cube shaped tank or container. This allows for the construction of a very tight, efficient system.

In another important embodiment, the present invention discloses that a cooled fluid (i.e., hydronic substance) is circulated through the first conduit/manifold to freeze the water immediately surrounding that conduit/manifold. As this process continues, ice freezes in an even but increasingly thicker layer about the second heat exchanger. In one embodiment, the water freezes in a direction extending from the first conduit/manifold outwardly. The freezing process may continue until a portion or the entire volume of water is frozen.

In another important embodiment, the present invention discloses that at any desired time interval, heated fluid may be circulated through the second conduit/manifold, thereby melting the ice immediately surrounding that conduit/manifold. As the ice melts, a liquid conduit/manifold or tunnel immediately surrounding the second conduit/manifold is formed. This process may be used to partially or completely melt the frozen block of ice. The physical contact between the first and second conduit/manifold or first and second heat exchangers actually increase the efficiency of the system. More particularly, by having the cooled first heat exchanger physically contacting the second heat exchanger, the effective thermal surface area is increased.

In an embodiment having greater efficiency, the tubing (both horizontal and vertical) is made of copper and contains fins (circular rings) protruding out configured for improving transfer of energy from inside to outside the tube, or outside to inside on the vertical tubes. In a preferred embodiment, a modularized housing (herein referred to as a linkable “cube”) is filled with water and gas/liquid present within the horizontal tubing is used to charge the system, thereby cooling the water (ultimately freezing the water). Then, the vertical tubing is configured to recover the energy by melting the ice and transporting the energy into the vertical tubes for air conditioning/cooling purposes. The fins (circular rings) and the copper tubing of the present invention provide an efficient way to charge and recover energy.

In another preferred embodiment, the present invention discloses at least one corrugated panel to ensure proper spacing of the tubing within the cube. In one embodiment, a panel is placed at the bottom of the cube. In other embodiments, individual panels (or support rails) are placed throughout the cube and/or panels are placed on opposite sides of the cube, allowing each “curtain” (serpentine tubing) to be slid into a corresponding slot (from the top).

In another important embodiment, the present invention discloses that the housing (cube (3D)) is charged from the bottom back to the upper front. And the order of discharging of the housing (cube (3D)) is from front left to rear right. The order of charging (bottom back to upper front) and discharging (left front to rear right) is deployed through the positioning of the first connector. The first connector on the charge manifold is connected to the back, bottom curtain and adapted to proceed forward resulting in freezing the liquid from bottom back to upper front. In this embodiment, an “expansion space” is left at the top of the cube, around the manifolds. Thus, in a liquid phase, the water covers only the curtains, excluding the manifolds (leaving the “expansion space” surrounding the manifolds). However, in a frozen/solid phase, the water expands into the “expansion space,” covering the manifolds. like an iceberg.

To achieve these general and specific objectives the present invention generally comprises: (a) a modular housing, (b) a first heat exchanger, and (c) a second heat exchanger. Each of these elements and their interaction with one another are discussed and elaborated upon in greater detail within the detailed description portion of this disclosure. By this reference, the subject matter discussed therein is expressly included within this portion of the disclosure.

The present invention imparts advantages over the existing arts by providing a relatively inexpensive and economical thermal storage system. The apparatus stores harvested, converted, abundant energy and stores it as thermal phase-changed energy (as ice) on the site of intended use prior to peak demand periods of power scarcity and higher costs. Whereas this action flattens the peak daytime demand curve of the electric grid, the average U.S. building requires approximately 40% of its energy menu demand to meet air conditioning needs. This building demand equates to the ISO's regional demand amounts for AC needs, which are dramatically higher in sunbelt and high humidity areas, especially during summertime major heat events, and during the daytime peak demand time events when the highest cost of electricity occurs.

The benefits have been proven that when Thermal Energy Storage is used by the electric grid's independent system operators (ISOs, the power traffic controllers of the national electrical grids) line loads are reduced. ISOs often reimburse the costs and installation of Thermal Energy Storage (TES) to their customers as mandated by the Federal Energy Regulatory Commission (FERC) as part of Demand Side Management (DSM) programs. Site installation of TES, behind the meter, to meet AC/cooling demands, permanently shifts the required kW of the building by removing the demand from the line loads prior to the high-cost daytime peak demand hours. The demand curves can be flattened or eliminated on a building-by-building basis by installation of TES devices such as the present invention as noted within this application. This addresses demand side management (DSM) or demand response (DR) on the electric grid. This increases grid reliability and therefore human health is improved while reducing significant costs.

The present invention also integrates dynamically produced renewable energies into the grid without any of their previously associated unreliability and/or congestion issues. The present invention's unique dynamic capabilities to constantly charge and discharge its energy storage as demanded, removes the “neck” constrictions of the typical renewable energy productions' “duck curve” (acting similarly with its unique abilities to flatten the daytime peak demand curve). This makes the CUBE's apparatus a prime tool of choice in renewable transitional energy management. The CUBE has no electrical current present, nor extremely high temperatures, eliminating the risk of fire known in other traditional renewable power storage “batteries.” The use of the present invention also removes potential electrocution risks to first responders in building emergency situations. The present invention is considered highly, sustainable, partially due to its long lifespan with its only moving internal parts being the phase-change fluids, requiring only minimal maintenance.

In addition to the foregoing, the present invention is relatively simple to construct, assemble, and use and is relatively inexpensive to operate. Furthermore, the invention is efficient, effective, functional, reliable, reusable, compact, rugged, and durable. It is important to note that the present invention permits the near immediate transition between charging and/or discharging of the system, without requiring a complete discharge or charge of the thermal reservoir between phase changes. Consequently, the thermal reservoir may be partially discharged and then recharged without having to completely discharge the system before recharging can occur. Similarly, the thermal reservoir may be partially recharged and then discharged without having to completely recharge the system before discharging can occur. Therefore, the present invention eliminates potential damage to the thermal storage and exchange system that otherwise often occurs for failure to completely discharge the system before the system is recharged. In addition, there is no need to completely recharge the system before the system is discharged. This advantage is important to allow continued use of the system to meet variable load demands without having to previously recharge the entire system.

The present invention achieves each of the above-stated objectives and overcomes the foregoing disadvantages and problems. These and other objectives and other features and advantages of the invention will be apparent from the detailed description, referring to the attached drawings, and from the claims. Thus, other aspects of the invention are described in the following disclosure and are within the ambit of the invention.

### BRIEF DESCRIPTION OF THE DRAWINGS

FIG. 1 is a partial, cross-sectional, exploded, isometric view of an on-site distributed demand thermal/heat storage and exchange system module;

FIG. 2 is a plan view of the system illustrated in FIG. 1, except with the cover being removed;

FIG. 3 is a cross-sectional, side-elevational view of the system illustrated in FIG. 1 as viewed from a plane generally defined by line III-III in FIG. 2;

FIG. 4 is an enlarged, partial, isometric view of a representative piping matrix having a portion of a first heat exchanger interwoven with a portion of a second heat exchanger as seen from a plane generally defined by line III-III in FIG. 2;

FIG. 5 is an enlarged, partial, cross-sectional, side-elevational view of an inlet port and an outlet port for the first heat exchanger and an inlet port for the second heat exchanger as found within the system illustrated in FIG. 1;

FIG. 6 is a schematic, partial, cross-sectional, plan view of a portion of the first heat exchanger interwoven with a portion of the second heat exchanger, wherein the invention is near completion of a charging cycle so that the heat storage medium generally assumes a frozen solid state;

FIG. 7 is a schematic, partial, cross-sectional, plan view of a portion of the first heat exchanger interwoven with a portion of the second heat exchanger as illustrated in FIG. 6, except that the heat storage medium is shown partially melted as occurs during the initial phases of a discharging cycle;

FIG. 8 is a partial, side-elevational view of a representative piping matrix having a portion of the first heat exchanger interwoven with a portion of the second heat exchanger as seen from a plane generally defined by line III-III in FIG. 2;

FIG. 9 is a partial, side-elevational view of an alternative embodiment of a representative piping matrix having a portion of the first heat exchanger interwoven with a portion of the second heat exchanger as would otherwise be seen from a plane generally defined by line III-III in FIG. 2, with FIG. 9 illustrating an alternative embodiment, wherein different interwoven patterns and locations of attachment are used;

FIG. 10 is a partial, isometric view of an alternative embodiment for the second heat exchanger;

FIG. 11 is a partial, plan view of an alternative embodiment, wherein the second heat exchanger has a generally serpentine configuration along a generally horizontal plane so that at least two adjacent piping matrixes are interconnected to form a continuous flow path;

FIG. 12 is a partial, plan view of a further alternative embodiment, wherein the first heat exchanger has a generally serpentine configuration along a generally horizontal plane so that at least two adjacent piping matrixes are interconnected to form a continuous flow path;

FIG. 13 is a schematic flow chart illustrating the interrelationship between various components of the on-site distributed demand thermal/heat storage and exchange system;

FIG. 14 is an isometric plan view of a thermal storage system in a preferred embodiment of the present invention;

FIG. 15 illustrates a thermal storage system in accordance with a preferred embodiment of the present invention, disposed within a housing;

FIG. 16 is a side view of the thermal storage system illustrated in FIG. 14;

FIG. 17 is a front sectional view of the thermal storage system illustrated in FIG. 14;

FIGS. 18A-D illustrate support rails that can be used to control spacing between individual conduits (or curtains) within the thermal storage system;

FIG. 19 illustrate other support rails (corrugated panels) that can be used to control spacing between individual conduits within the thermal storage system;

FIGS. 20A-D illustrate exemplary conduits used in certain embodiments of the present invention, where each conduit is bent into a general serpentine configuration and includes a plurality of circular fins;

FIGS. 21A-B illustrate exemplary manifolds (charge and recovery) used in certain embodiment of the present invention;

FIGS. 22A-B illustrate alternate manifolds (charge and recovery) used in certain embodiment of the present invention;

FIGS. 23A-B illustrates a heat storage medium (e.g., water) in a liquid and solid state, respectively, with an expansion zone when the heat storage medium is in a liquid state; and

FIG. 24 provides a perspective view of the CUBE with a corrugated panel on the inside bottom to provide spacing between individual curtains (conduits).

### DETAILED DESCRIPTION OF THE PREFERRED EMBODIMENT

The embodiments herein and the various features and advantageous details thereof are explained more fully with reference to the non-limiting embodiments that are illustrated in the accompanying drawings and detailed in the following description. Descriptions of well-known components and processing techniques are omitted so as to not unnecessarily obscure the embodiments herein. The description used herein is intended merely to facilitate an understanding of ways in which the embodiments herein may be practiced and to further enable those of skill in the art to practice the embodiments herein. Accordingly, the description or explanation should not be construed as limiting the scope of the embodiments herein.

Various modifications to the disclosed embodiments will be readily apparent to those skilled in the art, and the general principles defined herein may be applied to other embodiments and applications without departing from the spirit and scope of the present invention. Thus, the present invention is not limited to the embodiments shown but is to be accorded the widest scope consistent with the claims.

Exemplary embodiments are described with reference to the accompanying drawings. Wherever convenient, the same reference numbers are used throughout the drawings to refer to the same or like parts. While examples and features of disclosed principles are described herein, modifications, adaptations, and other implementations are possible without departing from the spirit and scope of the disclosed embodiments.

Referring to the drawings, wherein like numerals indicate like parts, to achieve the aforementioned general and specific objectives, the present invention generally comprises an apparatus 20 having: (a) a housing 22, (b) a first heat exchanger 24, and (c) a second heat exchanger 26. To better understand the function and interrelationship of these components, however, we will first discuss the environment into which such components will be placed.

The present invention generally includes various embodiments of a thermal storage and exchange system that can be used to cool temperatures within residential and/or commercial buildings. Of course, this invention could be built on a smaller scale to accommodate thermal needs of a lesser magnitude or smaller demand than that which is typically associated with a building.

More particularly, the present invention may be used selectively to cool and/or draw coolness from a thermal reservoir 28. The thermal reservoir 28 may comprise a large volume of heat storage medium 30 that is stored within the housing 22.

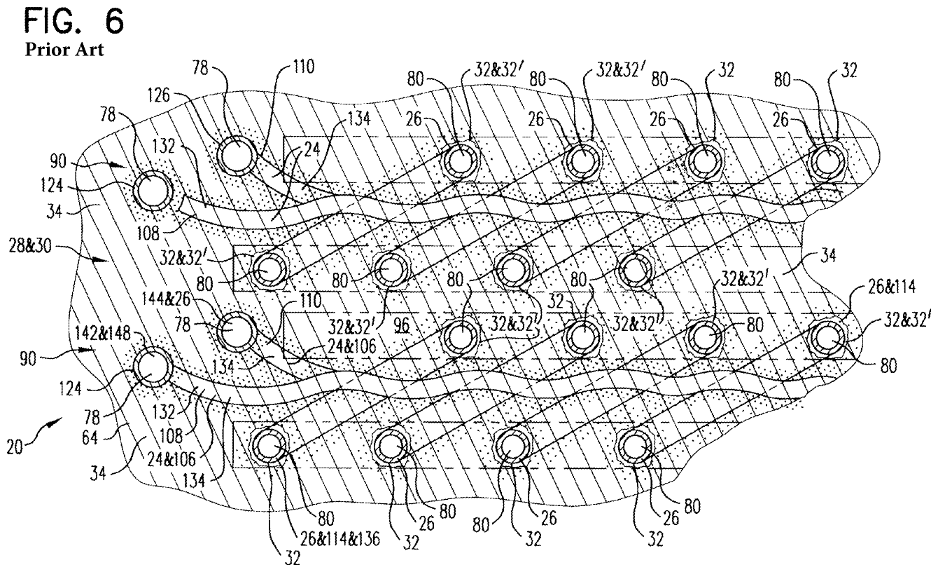

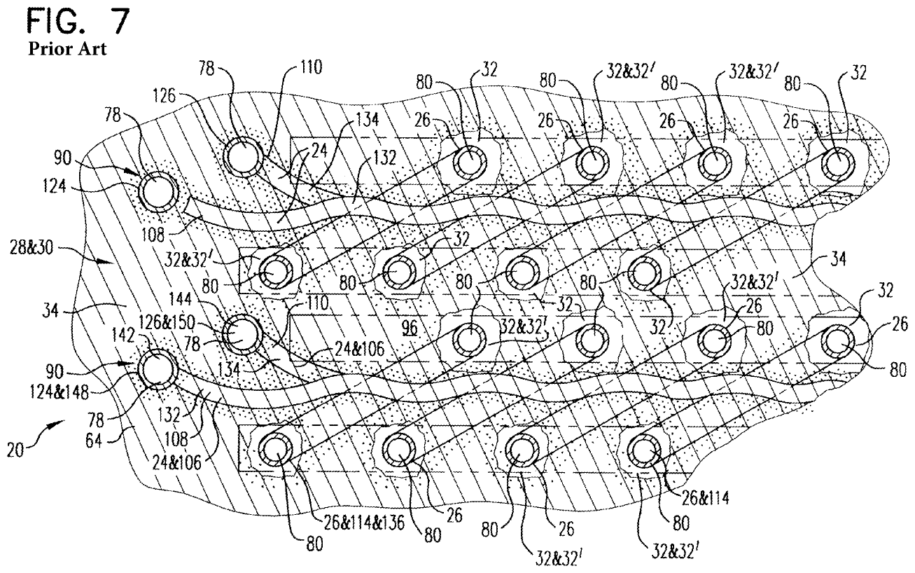

As best seen in FIGS. 6 and 7, the heat storage medium 30 should be capable of reversibly passing between a liquid phase 32 and a solid phase 34. For example, the heat storage medium 30 may comprise any heat absorbing material such as water, brine, glycol solution, or other phase change material (PCM) that can assume a liquid phase 32, fluid state and/or a solid phase 34, frozen state.

The housing 22 may take any desirable size, shape, and configuration. For example, in the preferred embodiment of the invention, the housing 22 is manufactured from rotationally moulded double-walled plastics filled and cross-linked with high density structural urethane insulation to form a large container, tank, vessel, tub, tray, or box having a first side 36, a second side 38, a third side 40, a fourth side 42, an integral floor 44 or base, and an opening 46 at the top of the housing 22. Of course, the housing 22 may be manufactured from other materials. For example, the housing 22 may be manufactured from concrete, metal, wood, plastic, compacted soil, composite materials, and the like.

As with conventional heat storage systems, the housing 22 is either supported by or is secured to a support structure 48. The support structure 48 may comprise the building itself. For example, the housing 22 may be placed upon a roof of the building or upon a floor especially dedicated to support mechanical hardware and equipment for the building. Alternatively, the housing 22 may be supported by or be secured to an independent support structure 48 that is positioned remotely from the building.

Since the present invention is so dramatically effective and efficient during operation, the invention can use a housing 22 that is much smaller in size than what would otherwise be required if a more conventional heat storage system were used. Consequently, the housing 22 of the present invention may be much more compact and may be used in areas of extremely limited access.

The floor 44 and sidewalls 36, 38, 40, and 42 of the housing 22 form and define an interior enclosure 50, compartment, or chamber that is capable of housing and containing the heat storage medium 30 therein. In essence, the housing 22 defines (in a preferred embodiment) an ice building storage tank, wherein the heat storage medium 30 or water may be contained, frozen and thawed.

The housing 22 may also be provided with a liner 52. The liner 52 is preferably positioned within the enclosure 50 between the interior sidewalls 36, 38, 40, and 42 of the housing 22 and the heat storage medium 30. It is intended that the liner 52 be capable of at least partially enveloping the heat storage medium 30. For example, the liner 52 may comprise sheets of flexible, impermeable, plastic or rubber that physically insulate the heat storage medium 30 from the interior sidewalls 36, 38, 40, and 42 of the housing 22. The liner 52 may also thermally insulate the heat storage medium 30 from the housing 22 and surrounding atmosphere 54.

If desired, the housing 22 may also be provided with additional thermal insulation 56. For example, the additional thermal insulation 56 may be necessary to adequately insulate the housing 22 if the housing 22 is manufactured from metal or plastic. The thermal insulation 56 may be placed either against the interior and/or exterior sidewalls 36, 38, 40, and 42, and/or the floor 44 of the housing 22.

The large opening 46 positioned at the top of the housing 22 permits the placement of the first heat exchanger 24 and second heat exchanger 26 into the enclosure 50. Furthermore, the large opening 46 permits servicing and maintenance of the apparatus 20.

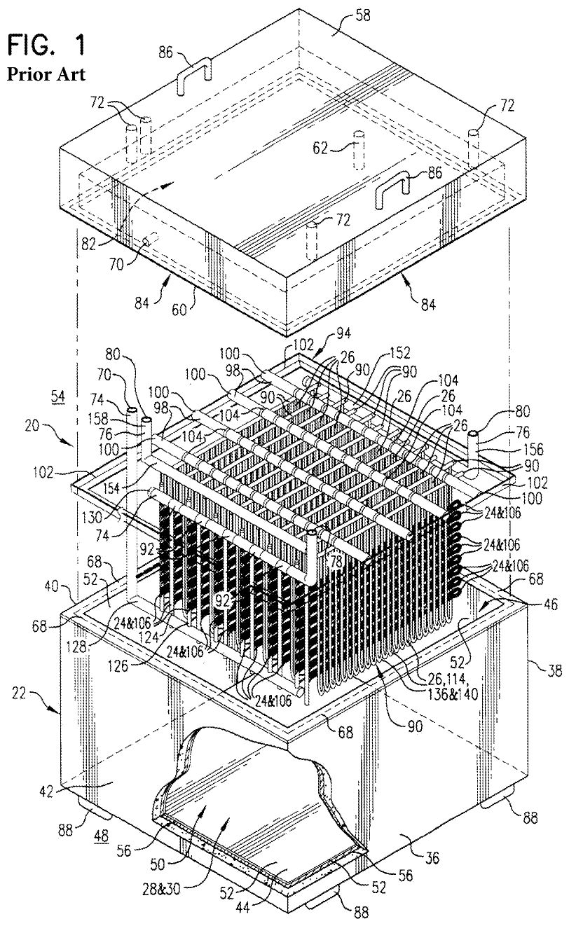

In the preferred embodiment of the invention, as shown in FIG. 1, the housing 22 is also provided with a removable or hinged lid 58, hood, or roof. The lid 58 enables the large opening 46 to be closed. When the lid 58 is properly positioned atop the housing 22, the interior or lower surface 60 of the lid 58 defines a ceiling for the enclosure 50. The lid 58 shall be provided with high-density urethane thermal insulation 56. The lid 58 may also have an air vent 62, ventilating stack, exhaust stack, hole, or chimney, located therein, which enables the removal of excess atmospheric pressure held within the enclosure 50.

It is the intention of the inventor that only an appropriate amount of heat storage medium 30 be placed within the enclosure 50. For example, the heat storage medium 30 is poured into the enclosure 50 only after the first heat exchanger 24 and the second heat exchanger 26 have already been placed in position within the enclosure 50. A sufficient amount or volume of heat storage medium 30 is poured into the enclosure 50 until a substantial portion of the first heat exchanger 24 and the second heat exchanger 26 are immersed therein. However, an adequate expansion area above an upper surface 64 of the heat storage medium 30 should be maintained. The expansion area basically defines a freeboard 66 between the upper surface 64 of the heat storage medium 30 and an upper edge or rim 68 of the sidewalls 36, 38, 40, and 42. This feature is discussed in greater detail below.

If needed or desired, the housing 22 and/or lid 58 may be provided with an overflow conduit 70, tube, side vent, or spillway through which excess liquid heat storage medium 30 may be expelled. Overflow conduit 70 is shown in FIG. 1. The present invention may also or alternatively be provided with a water-level indicator (not shown) and/or overflow protection switch (not shown) that would be activated if the upper surface 64 of the heat storage medium 30 exceeds a predetermined level.

Holes 72 may be provided within the housing 22 and/or lid 58 to permit the passage of piping 74 and 76 therethrough. Thus, the holes 72 permit the ingress and egress of a refrigerant 78 (or any chilled fluid or gas) and other fluid and/or gas 80, contained within the piping 74 and 76, respectively, to pass into and out of the enclosure 50.

Refrigerant 78 may also be referred to as a first fluid or gas that is capable of being contained and transported within a first conduit 106. Fluid or gas 80 may also be referred to as a second fluid or gas that is capable of being contained and transported within a second conduit 114. If desired, flashing (not shown) may be placed about the piping 74 and/or 76 at each hole 72 to prevent contaminants from entering into the enclosure 50.

As referenced above, the lid 58 may also be provided with a hinge (not shown) to enable the easy raising and lowering of the lid 58 into place atop the housing 22 sidewalls 36, 38, 40, and 42. As shown in FIG. 1, a recess 82 and/or seat may be positioned about a periphery or rim 84 of the lid 58 to receive the upper rim 68 of the housing 22 and secure the lid 58 in place. If needed and/or desired, a gasket (not shown) may be placed about the recess 82 or seat of the lid 58. The lid 58 may also be provided with one or more handles 86 and/or loops that accommodate the raising and lowering of the lid 58.

In certain embodiments, feet 88 may be formed integrally within the floor 44 and/or sidewalls 36, 38, 40, and 42 of the housing 22. The feet 88, or alternatively the housing 22, may be provided with one or more support legs (not shown).

The primary function of the first heat exchanger 24 and the second heat exchanger 26 is to selectively and reversibly charge and/or discharge the thermal reservoir 28. More particularly, the primary function of the first heat exchanger 24 is to selectively charge the thermal reservoir 28. The primary function of the second heat exchanger 26 is to selectively discharge the thermal reservoir 28. Those skilled in the art will understand that the opposite may also be true.

The combination of the first heat exchanger 24 and the second heat exchanger 26 can generally be described as comprising one or more curtains or panels that are positioned within the enclosure 50 and are at least partially submerged within the heat storage medium 30. Since both the first heat exchanger 24 and the second heat exchanger 26 are positioned upon the curtain or panel, such a combination shall be referred to as a heat exchanger curtain 90. As discussed in greater detail below, each “curtain” comprises a serpentine shaped tubing or conduit.

It is the general intention of the inventor that a plurality of interconnected heat exchanger curtains 90 be used within the enclosure 50 and apparatus 20. However, there may be a situation wherein only a single heat exchanger curtain 90 is needed. Each heat exchanger curtain 90 may be so sized and configured that under predetermined conditions each such curtain 90 will have a predictable capacity to charge and/or discharge the surrounding heat storage medium 30. Consequently, a calculation can be made as to the number of heat exchanger curtains 90 that must be employed or operated to meet or exceed any particular air conditioning and/or refrigeration load or demand. If more cooling capacity is needed, then more heat exchanger curtains 90 may be used and/or employed.

Within one embodiment of the present invention, each heat exchanger curtain 90 functions as a separate cassette, magazine, or cartridge that can be added as needed to the apparatus 20. The engagement of additional heat exchanger curtains 90 may be accomplished by their physical attachment to the remaining apparatus 20, as would occur when an originally installed apparatus 20 is being altered or modified for greater cooling capacity.

Alternatively, a sufficient number of heat exchanger curtains 90 may be initially placed within the enclosure 50, and then a switching device or valve mechanism 92 may be used to engage or disengage the proper number of curtains 90 for the required task. In essence, each individual heat exchanger curtain 90 could function separately from the remaining heat exchanger curtains 90. Valve mechanism 92 is shown in FIG. 1.

Within a further embodiment of the invention, all heat exchanger curtains 90 that are positioned within the enclosure 50 may be operatively connected to one another. Thus, when the apparatus 20 is operated, all heat exchanger curtains 90 are operated simultaneously, albeit, possibly at a lower rate of efficiency than of what they are capable.

When more than one heat exchanger curtains 90 are used, each individual curtain 90 is secured by the manifold and corrugated panels (discussed in greater detail below). Alternatively, they could be suspended from a support rack 94, brace, framework, or rig. It is the intention of the inventor that the heat exchanger curtains 90 be secured to the manifold, corrugated panels, and/or support rack (depending on the embodiment) so that each curtain 90 has a spaced orientation with or relationship to adjacent curtains 90, and that a space 96 or crevice be located between adjacent curtains 90.

In a first embodiment, simple to employ, but limited in functionality, the support rack 94 comprises a plurality of beams, joists, or girders that generally span across the width or length of the enclosure 50. For example, the beams of the support rack 94 may comprise a plurality of pipes 98 to which each heat exchanger curtain 90 is attached, and from which each heat exchanger curtain 90 is suspended. As can be easily seen within the figures, and particularly within FIG. 1, the beams or pipes 98 have a generally orthogonal orientation with respect to the generally planar heat exchanger curtains 90.

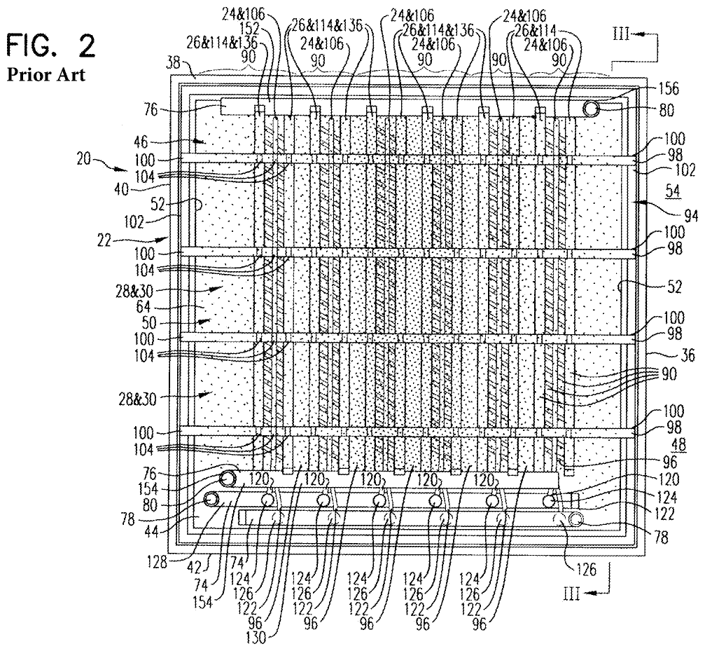

As best seen in FIG. 2, the terminal ends 100 of the beams or pipes 98 are supported within a collar 102 of metal, L-shaped angle-iron, that is positioned about the upper rim 68, edge, ridge, or periphery of the housing 22 sidewalls 36, 38, 40, and 42. Any appropriate means 104 to attach or secure the heat exchanger curtains 90 to the beams or pipes 98 may be used. For example, lengths of rubber or plastic, rope, cord, cable, chains, wire, ties, belts, bands, straps, buckles, hooks, pins, screws, bolts, nails, or any other means for attaching such elements together may be used.

It should be appreciated that, in the foregoing embodiment, it is generally intended that the heat exchanger curtains 90 be literally suspended within the heat storage medium 30, so that they are spaced above and do not contact the floor of the enclosure 50. However, in preferred embodiments (discussed below), structures can also (or alternatively) be positioned above, below, within, and on the sides (e.g., manifold, corrugated panels, etc.) to control spacing between individual curtains or conduits.

Both the first heat exchanger 24 and the second heat exchanger 26 operate upon the principle of thermal equilibrium. In essence, the law of thermal equilibrium states that when two bodies having different temperatures are exposed to one another, the temperature of both bodies will change until a uniform temperature is attained between both bodies. In other words, the warmer body will become cooler and the cooler body will become warmer until an equilibrium or balance in temperature is reached.

In very general terms, the first heat exchanger 24 defines or is connected to a refrigeration system. The refrigeration system is used to remove heat from the heat storage medium 30, thereby freezing the medium 30. Once the heat storage medium 30 is frozen, the coolness stored therein can be used when a demand arises. Any appropriate means to reduce the temperature of the heat storage medium 30 may be utilized.

Again, in very general terms, the second heat exchanger 26 also defines or is connected to a refrigeration system, albeit a different refrigeration system component. However, this second refrigeration system component is used to remove heat from a particular application such as from the air located within a building, cold storage area, or the like. The means to accomplish this task is the thermal exposure of the second heat exchanger 26 to the frozen heat storage medium 30. In other words, thermal exposure of the fluid or gas 80, contained within the second heat exchanger 26, to the lower temperatures of the frozen heat storage medium 30 reduces the temperature of the fluid or gas 80.

Conversely, thermal exposure of the cooled heat storage medium 30 to the heated fluid or gas 80 causes the heat storage medium 30 to absorb heat therefrom, which further melts the medium 30 to a liquid state. However, the cooled fluid or gas 80 may be transported to a remote site to absorb heat from a desired application. Once the heat storage medium 30 reaches a predetermined state of discharge, the first heat exchanger 24 may be activated to recharge and reduce the temperature of the heat storage medium 30.

The particular design of the first heat exchanger 24 and the second heat exchanger 26, and their interrelationship with one another will now be discussed. Within a further embodiment of the invention, a primary element of the first heat exchanger 24 is a length of hollow tubing that forms and defines a generally continuous first conduit 106. The first conduit 106 should be capable of being at least partially positioned within the enclosure 50. More particularly, the first conduit 106 is capable of being at least partially submerged within the heat storage medium 30 contained within the enclosure 50.

The first heat exchanger 24 functions as means for decreasing the temperature of the heat storage medium 30. To accomplish this task, the refrigerant 78 or other chilled fluid is placed within and passed through the first conduit 106 of the first heat exchanger 24. Within this document, the term refrigerant is used to define both what would be considered a traditional refrigerant, such as ammonia or other chemical, and a chilled or cooled fluid, such as but not limited to chilled water, brine or glycol solution.

Any appropriate means for decreasing the temperature of the refrigerant 78 below the temperature of the surrounding fluid may be used. For example, within the preferred embodiment of the invention a chiller is used. Furthermore, any appropriate means may be used to transport the refrigerant 78 through the first conduit 106. Within the preferred embodiment of the invention, a pump is used for this purpose. The refrigerant 78 may simply comprise a chilled brine, refrigerant, glycol solution, or other fluid material that is chilled at a remote location and is transported into enclosure 50. Those skilled in the art will understand that in the present invention, which may or may not be used in conjunction with a separate evaporator, the cooled refrigerant is simply transported through the first heat exchanger 24 and first conduit 106.

As explained above, the first heat exchanger 24 may include any appropriate means for decreasing the temperature of the refrigerant 78 below the temperature of the heat storage medium 30 that surrounds the first conduit 106. Consequently, when activated, the first heat exchanger 24 is capable of selectively reducing the temperature of the heat storage medium 30 within the enclosure 50.

Within the preferred embodiment of the invention, the first conduit 106 is manufactured from a substance that can easily cool and freeze adjacent and surrounding heat storage medium 30, and yet withstand the nearly constant temperature and volume changes that occur within the frozen heat storage medium 30. For example, the first conduit 106 may be manufactured from rubber, plastic, ethylene-propylene-terpolymer (which is commercially known as EPDM), from radiant heat tubing, and/or from any other appropriate material. It should be appreciated, however, that in an alternate, preferred embodiment (discussed in greater detail below), the tubing is manufactured from cooper, with a plurality of fins for thermal transfer.

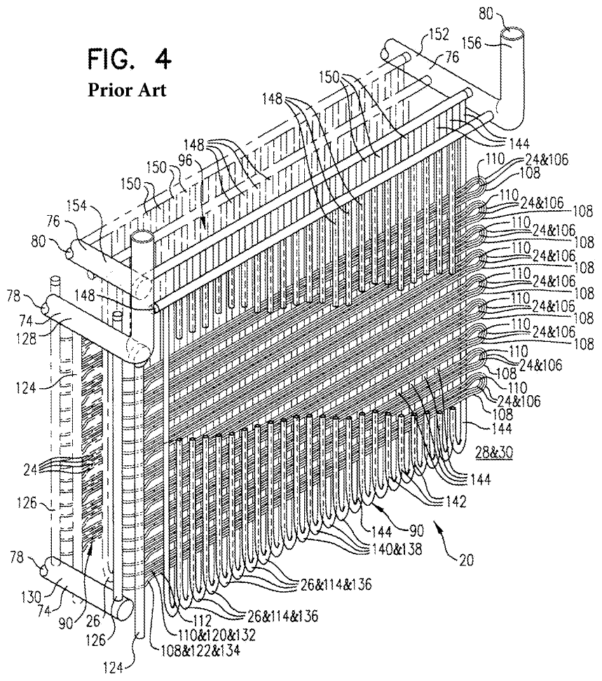

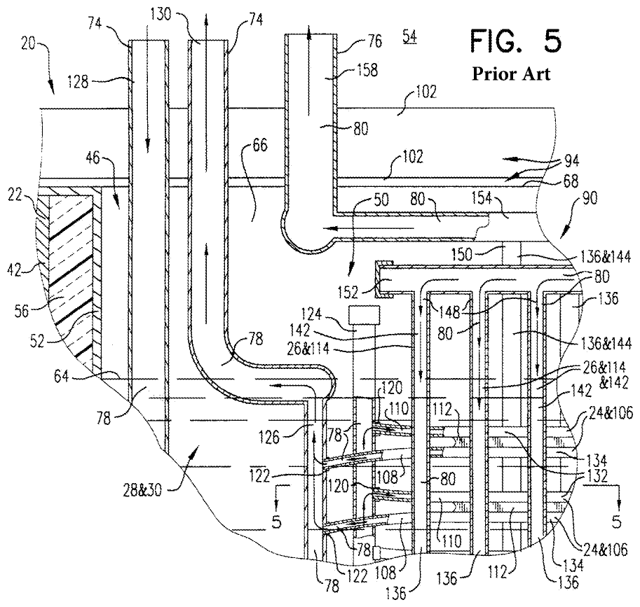

As best seen in FIGS. 4 and 5, the preferred flexible radiant heat tubing is manufactured to have two parallel tubes 108 and 110 that are spaced apart by a webbing 112 that spans therebetween. In one embodiment, the first conduit 106 is manufactured from a generally flexible material having a coefficient of thermal conductivity of about 0.02 to 10.0 BTU-FT/FT2-H-° F. Within this embodiment, the first conduit 106 may be manufactured from a material being sold under the trademark RADIANT ROLL that has a coefficient of thermal conductivity of about 0.081 BTU-FT/FT2-H-° F.

The particular placement of the first conduit 106 within the heat exchanger curtain 90 will be discussed following a description of the second heat exchanger 26. A primary element of the second heat exchanger 26 is a length of hollow tubing that forms and defines a generally continuous second conduit 114. The second conduit 114 should also be capable of being at least partially positioned within the enclosure 50. More particularly, the second conduit 114 is capable of being at least partially submerged within the heat storage medium 30 contained within the enclosure 50.

The second heat exchanger 26 functions as means for increasing the temperature of the heat storage medium 30, or in other words, for drawing coolness from the frozen or nearly frozen heat storage medium 30 for use within the building or another application. To accomplish this task, a fluid or gas 80 is placed within and passed through the second conduit 114. In essence, the second conduit 114 defines and functions as a radiator through which heated fluid or gas 80 may be passed.

If desired, the second heat exchanger 26 may include any appropriate means to increase the temperature of the fluid or gas 80 contained within the second conduit 114 to a temperature that is above the temperature of the heat storage medium 30 surrounding the second conduit 114. In practice, however, the fluid or gas 80 contained within the second conduit 114 becomes heated as a natural consequence of being circulated through an auxiliary or ancillary air conditioner system component or other application, whereupon the fluid or gas 80 absorbs heat at a remote location.

Consequently, when activated, the second heat exchanger 26 is capable of selectively removing coolness from the heat storage medium 30 contained within the enclosure 50 and reduce the temperature of the fluid or gas 80 that is contained within the second conduit 114. Any appropriate means may be used to transport the fluid or gas 80 through the second conduit 114. Within the preferred embodiment of the invention, a pump is used for this purpose.

It is preferred that the second conduit 114 be manufactured from a substance that can easily transfer and expend heat from the fluid or gas 80 contained therein to the adjacent and surrounding heat storage medium 30. For example, the second conduit 114 may be manufactured from metal, such as from brass, copper, and/or from any other appropriate material. The inventor prefers to use copper tubing for the second conduit 114. Fins may also be used (see discussion below).

In one embodiment of the present invention, the second conduit 114 is manufactured from a material having a coefficient of thermal conductivity of about 100 to 1000 BTU-FT/FT2-H-° F. Within the preferred embodiment of the invention, the second conduit 114 may be manufactured from copper tubing having a coefficient of thermal conductivity of about 232.0 BTU-FT/FT2-H-° F.

Since heated fluid and/or gas 80 may be continually passed through the second conduit 114, the heat storage medium 30 immediately contacting and surrounding the second conduit 114 would not become frozen. It should be remembered that cold refrigerant 78 is not passed through the second conduit 114. Consequently, the second conduit 114 is not exposed to significant volume changes that can occur within the frozen heat storage medium 30.

Instead, as the thickness of the frozen heat storage medium 30 surrounding the first conduit 106 grows and enlarges, the liquid heat storage medium 30 surrounding the second conduit 114 is simply pushed along a de facto liquid conduit 32′ that surrounds the length of the second conduit 114 and, therefore, does not exert any significant pressure or force upon the second conduit 114. In one embodiment, a conduit length of 22 to 24 inches is preferred. It should be appreciated however that other lengths are within the spirit and scope of the present invention.

In other words, if the block of ice is only partially melted and the cooling process begins again, new frozen ice is formed about the first conduit 106. Such newly frozen ice, however, expands and displaces much of the liquid water. In other words, the freezing water has a place to push unfrozen water back up to the surface. The liquid conduits 32′ surrounding the second conduit 114 allow the liquid water to be displaced therethrough, thereby relieving the entire system of undue pressures imparted by freezing, thawing, and refreezing ice.

Within the preferred embodiment of the invention, the second heat exchanger 26 is manufactured from metal tubing. Such metal tubing has an extremely high value of thermal conductivity. Consequently, the metal tubing can quickly transmit heat to the ice and liquid contained in the liquid conduit 32′. Convection currents that are generated within the liquid conduit 32′ that surround the metal tubing actually scrub the ice to melt it more rapidly. As a result, the entire ice storage system of the present invention can be rapidly discharged. In contrast, other systems require a substantial period of time to discharge the system or melt the ice and may require mechanical agitation.

Due to the high thermal conductivity of the metal tubing within the second heat exchanger 26, the block of ice can be more rapidly discharged or melted than was previously available in the industry. Such rapid discharge has an additional benefit in maintaining a lower or cooler temperature within the second heat exchanger 26 throughout the discharge procedure, for a longer period of time.

In the preferred embodiment of the invention, the second conduit 114 has a generally vertical orientation. Consequently, the liquid heat storage medium 30 may be pushed upwardly along a channel immediately exterior of the second conduit 114. Alternatively, if desired, the apparatus 20 of the invention may be configured so that at least a portion of the second conduit 114 has a generally horizontal orientation, whereupon the liquid heat storage medium 30 will be pushed along a channel immediately exterior of the second conduit 114 to the ends of the second conduit 114.

Even if the growth of ice or frozen heat storage medium 30 eventually contacts the second conduit 114, such ice or frozen heat storage medium 30 could be immediately melted by the thermal release of heat contained within the second conduit 114, if any. Consequently, it would be nearly impossible for an operator to damage the apparatus 20 since heated fluid and/or gas 80 are being passed through the second conduit 114.

Even if no heated fluid and/or gas 80 is passed through the second conduit 114 and the system is completely frozen solid, the apparatus 20 is not exposed to a danger of breakage, because the apparatus 20 is specifically designed to eliminate captured pockets of liquid heat storage medium 30. Instead, the liquid heat storage medium 30 is expelled primarily upwardly during the freezing process. In addition, and this is an extremely important and significant feature of the present invention, both the first heat exchanger 24 and the second heat exchanger 26 can be operated simultaneously. Thus, there is no need nor requirement that the thermal reservoir 28 be completely discharged prior to recharging the thermal reservoir 28.

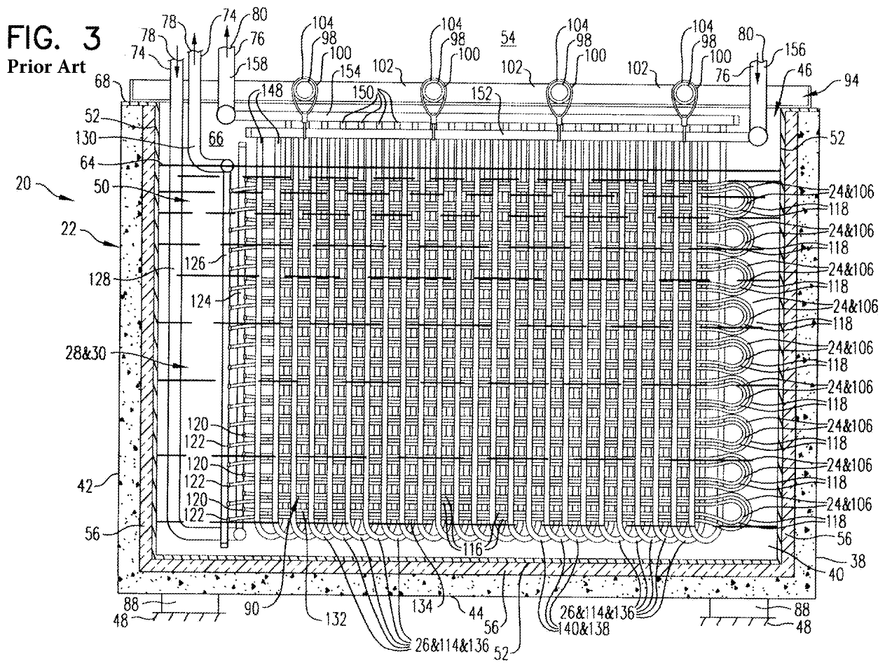

As illustrated within the figures, the first conduit 106 preferably has a generally serpentine configuration with a plurality of spaced, generally parallel legs 116 (preferably 22-24 inches in length). As best seen in FIG. 3, one or more ends 118 of the legs 116 of the first conduit 106 can be bent to form a generally U-shaped, V-shaped, Z-shaped, N-shaped, M-shaped, or W-shaped conduit. Since the first conduit 106 is generally manufactured from a semi-rigid finned copper material or other metal material, the bends at the ends 118 of the legs 116 are created by machine-bending to exacting dimensions. It should be appreciated that other embodiments (e.g., other conduits and/or methods of manufacturing the same) are within the spirit and scope of the present invention. However, regardless of the embodiment, the bending (or folding) should be done with precision to obtain uniform spacing between each parallel leg of the serpentine configuration (e.g., 116).

With respect to the legs, to obtain the full benefit and effect of the refrigerant passing through the first conduit 106, the inventor prefers to arrange the various legs 116 of the first conduit 106 so that the average temperature between adjacent legs 116 are approximately equal. To accomplish this, the first conduit 106 can utilize multiple pairs of bent legs 116. Each pair of bent legs 116 has a first terminal end 120 and an adjacent second terminal end 122. Each first terminal end 120 of each pair of bent legs 116 comprised within the first conduit 106 is operably connected to an input pipe 124. Each second terminal end 122 of each pair of bent legs 116 comprised within the first conduit 106 is operably connected to an output pipe 126. The input pipe 124 and the output pipe 126 are preferably positioned adjacent or near to one another.

If more than one heat exchanger curtain 90 is used, then the first conduit 106 found within each exchanger curtain 90 is provided with its own input pipe 124 and output pipe 126. Each of the many input pipes 124 is then operably connected to a main input pipe 128 that enters into the enclosure 50. Similarly, each of the many output pipes 126 is operably connected to a main output pipe 130 that exits out of the enclosure 50.

Thus, a closed system is created, wherein refrigerant 78 is passed through the main input pipe 128 and is distributed through each of the various individual input pipes 124 associated with each heat exchanger curtain 90. The refrigerant 78 then passes from the individual input pipes 124 into a first leg 132 of the first conduit 106, around the bent end 118, and down a second leg 134 of the first conduit 106, whereupon the refrigerant 78 enters the individual output pipe 126 associated with its respective heat exchanger curtain 90. The refrigerant 78 is then collected from the various individual output pipes 126 of each heat exchanger curtain 90 and is passed into the main output pipe 130 to exit from the enclosure 50.

It is the general intention of the inventor that the flow of refrigerant 78 within any given leg 116, and more particularly within any first leg 132 and/or second leg 134 of the plurality of legs 116 found within the first conduit 106 of any given heat exchanger curtain 90, will have an opposite flow direction than the flow direction of the refrigerant 78 found within any immediately adjacent leg 116. This is the preferred embodiment of the invention. Of course, other configurations or flow patterns could be used. However, the inventor believes that use of such alternative configurations or flow patterns would render the invention less efficient.

By applying a pressure to the refrigerant 78, the refrigerant 78 can be forced to pass through each and every leg 116 of each first conduit 106 within the enclosure 50. In addition, such passage of the refrigerant 78 through each first conduit 106 will have a uniform and predictable effect on the surrounding heat storage medium 30.

In a similar manner, the second conduit 114 preferably has a generally serpentine configuration with a plurality of spaced, generally parallel legs 136. One or more ends 138 of the legs 136 of the second conduit 114 can be bent to form a generally U-shaped, V-shaped, Z-shaped, N-shaped, M-shaped, or W-shaped conduit.

As best seen within FIG. 4, since the second conduit 114 is generally manufactured from a relatively stiff material or metal such as copper, the legs 136 may be formed from straight lengths of tubing (preferably 22-24 inches in length). In preferred embodiments, continuous straight lengths are custom bent to specifications to achieve the desired serpentine configurations with minimal surface imperfections to facilitate smooth flow of liquids within. It should be appreciated, however, that other embodiments (e.g., using U-bend fixtures or U-bend joints 140 that can then be soldered onto the desired end or ends 138 of adjacent first leg 142 and second leg 144 to form the generally serpentine configuration) are also within the spirit and scope of the present invention.

To obtain the full benefit and effect of the fluid or gas 80 passing through the second conduit 114, the inventor prefers to arrange the various legs 136, and more particularly the first leg 142 and second leg 144 of the second conduit 114, so that the average temperature between adjacent legs 136 are approximately equal.

To accomplish this, the second conduit 114 also utilizes multiple pairs of bent legs 136. Each pair of bent legs 136 has a first end 148 and an adjacent second end 150. Each first end 148 of each pair of bent legs 136, comprised within the second conduit 114, is operably connected to a supply pipe 152. Each second end 150 of each pair of bent legs 136, comprised within the second conduit 114, is operably connected to a return pipe 154. The supply pipe 152 and the return pipe 154 are preferably positioned adjacent or near to one another. If more than one heat exchanger curtain 90 is used, then the second conduit 114 found within each exchanger curtain 90 is provided with its own supply pipe 152 and return pipe 154. Each of the many individual supply pipes 152 is then operably connected to a main supply pipe 156 that enters into the enclosure 50. Similarly, each of the many individual return pipes 154 is operably connected to a main return pipe 158 that exits out of the enclosure 50.

Thus, a closed system is created, wherein fluid and/or gas 80 is passed through the main supply pipe 156 and is distributed through each of the various individual supply pipes 152 associated with each heat exchanger curtain 90. The fluid and/or gas 80 then passes from the individual supply pipes 152 into the first leg 142 of the second conduit 114, around the bent end 138, and down the second leg 144 of the second conduit 114, whereupon the fluid and/or gas 80 enters the individual return pipe 154 associated with its respective heat exchanger curtain 90. The fluid and/or gas 80 is then collected from the various individual return pipes 154 of each heat exchanger curtain 90 and is passed into the main return pipe 158 to exit from the enclosure 50.

Again, it is the general intention of the inventor that the flow of fluid and/or gas 80 within any given leg 136, and more particularly within any first leg 142 and/or second leg 144 of the plurality of legs 136 found within a second conduit 116 of a single heat exchanger curtain 90, will have an opposite flow direction than the flow direction of the fluid and/or gas found within any immediately adjacent leg 136. Again, this is the preferred embodiment of the invention. Other configurations or flow patterns could be used. However, the inventor believes that use of such alternative configurations or flow patterns would render the invention less efficient.

By applying a pressure to the fluid and/or gas 80, the fluid and/or gas 80 can be forced to pass through each and every leg 136 of each second conduit 114 within the enclosure 50. In addition, such passage of the fluid and/or gas 80 through each second conduit 114 will have a uniform and predictable effect on the surrounding heat storage medium 30.

As can be seen in the various figures, a wide variety of differently configured heat exchanger curtains 90 can be created. The primary difference between the various illustrated embodiments of the invention is the manner within which the legs 116 of the first conduit 106 are oriented with respect to the legs 136 of the second conduit 114.

For example, as shown in FIGS. 1 through 7, and best seen in FIG. 4, each leg 116 of the first conduit 106 may be juxtaposed and interwoven or intermeshed between the respective first leg 142 and second leg 144 of each bent section of the second conduit 114. In other words, the first conduit 106 at least partially interweaves or intermeshes with the second conduit 114.

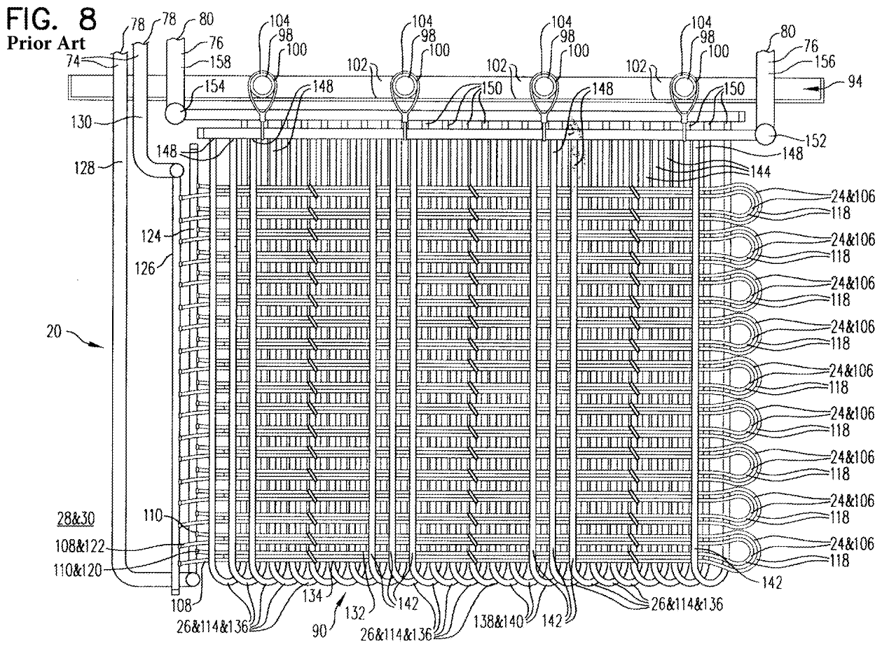

Since the first heat exchanger 24 is actually woven into and/or around the second heat exchanger 26, each heat exchanger 24 and 26 imparts structural integrity to the other heat exchanger. Alternatively, as shown in FIG. 8, each leg 116 of the first conduit 106 may be juxtaposed and interwoven or intermeshed between only a select few of the first legs 142 and second legs 144 of various bent sections of the second conduit 114.

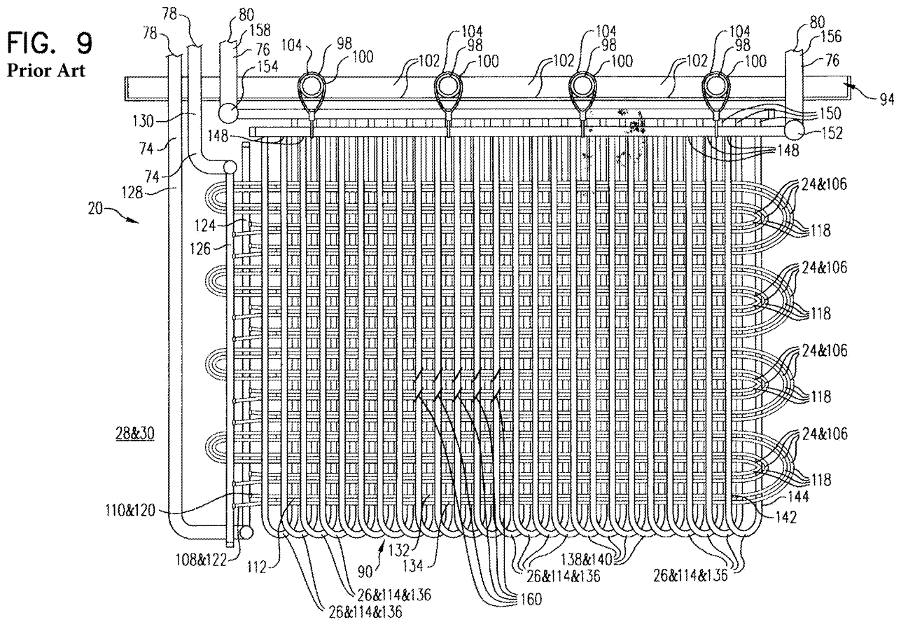

In an even further embodiment of the invention, as shown in FIG. 9, the length of the first conduit 106 may be extended such that it is capable of folding back to form an additional set of legs 116. As a result, first conduit 106 generally has three (3) bent ends 118 and four (4) separate legs 116 to each bent section of the first conduit 106.

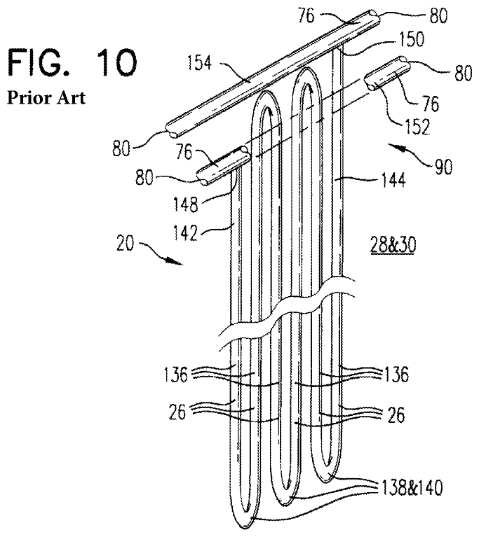

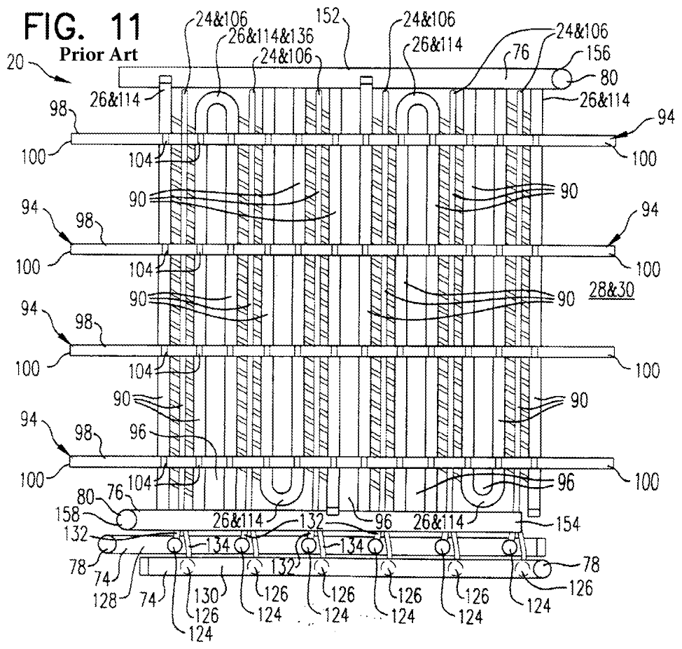

FIG. 10 illustrates an alternative embodiment for the second conduit 114, wherein the length of a single second conduit 114 is so extended that it may be bent to have five (5) separate bent ends 138 and six (6) separate legs 136 to each bent section of the second conduit 114.

FIG. 11 illustrates an alternative embodiment of the invention, wherein the second conduits 114 assume a generally horizontal orientation and are bent to participate in and be interconnected between at least two successively adjacent heat exchanger curtains 90.

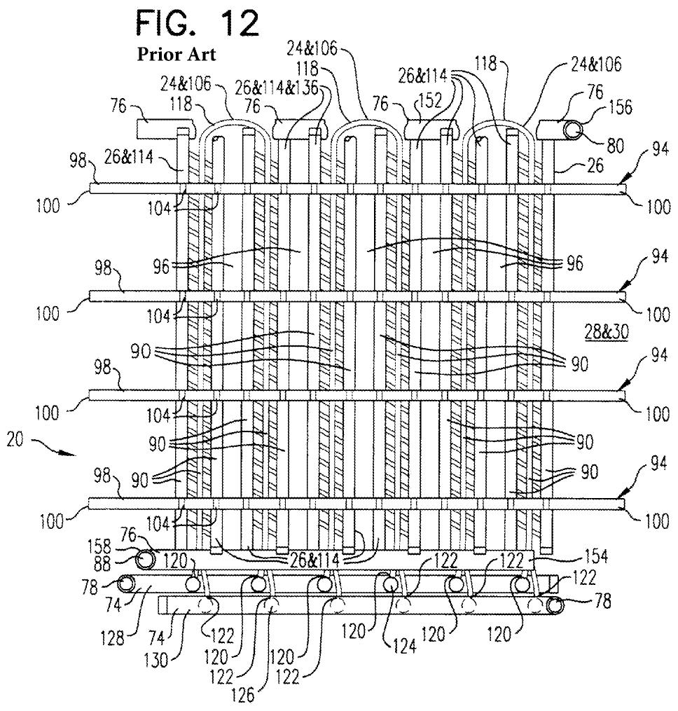

FIG. 12 illustrates a preferred embodiment of the invention wherein the first conduits 106 assume a generally horizontal orientation and are bent to participate in and be interconnected between at least two successively adjacent heat exchanger curtains 90.

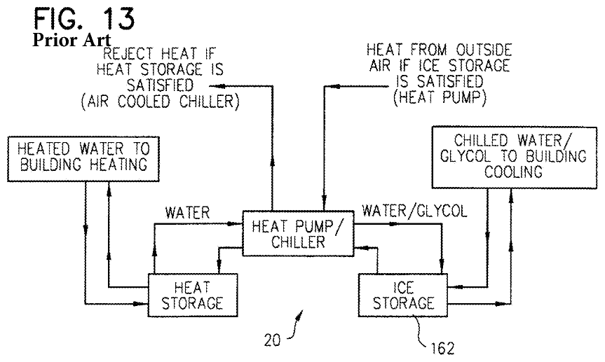

FIG. 13 is a schematic flow chart illustrating the interrelationship between various components of the invention. The foregoing explanation was primarily focused upon the apparatus 20 and processes used within the ice storage component 162 shown in the schematic flow chart. The inventor believes that the steps, processes, and flow patterns disclosed within FIG. 13 should be self-explanatory to a person skilled in the relevant art, once such person is provided with a copy of this document.

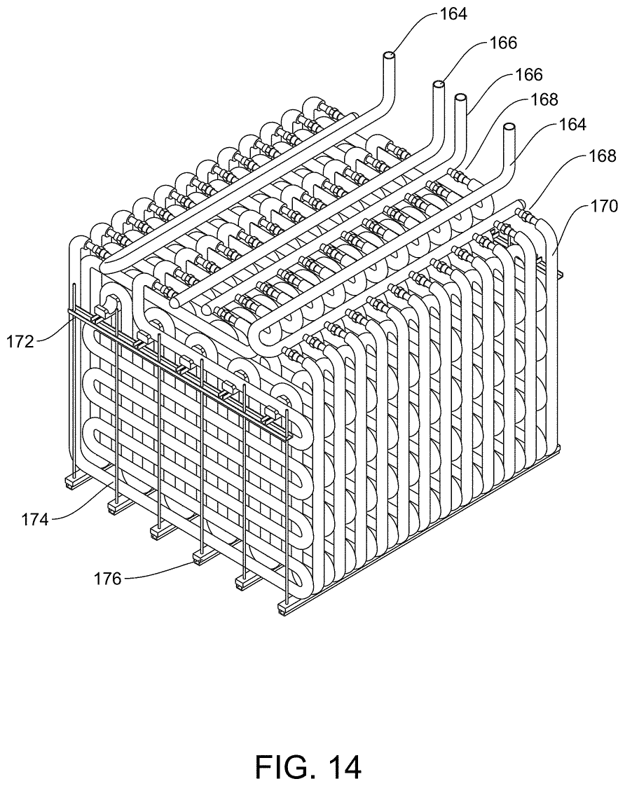

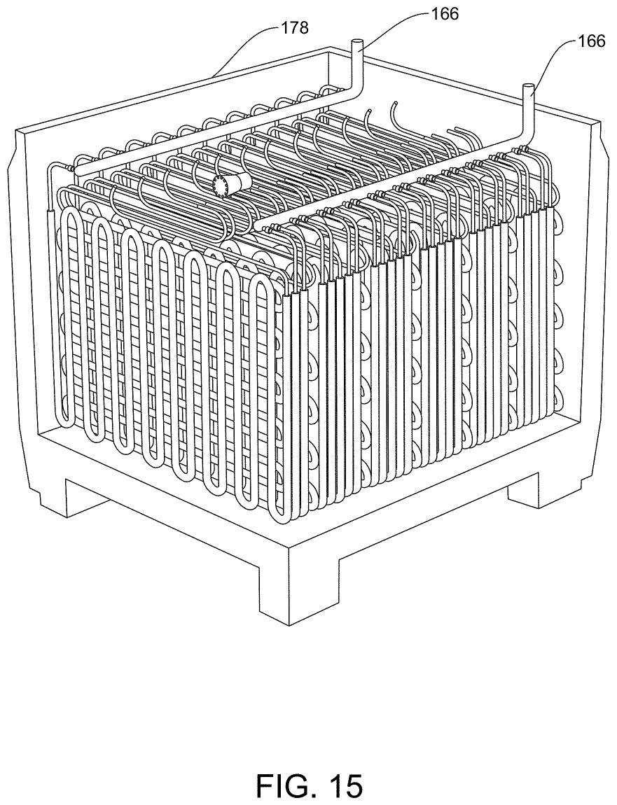

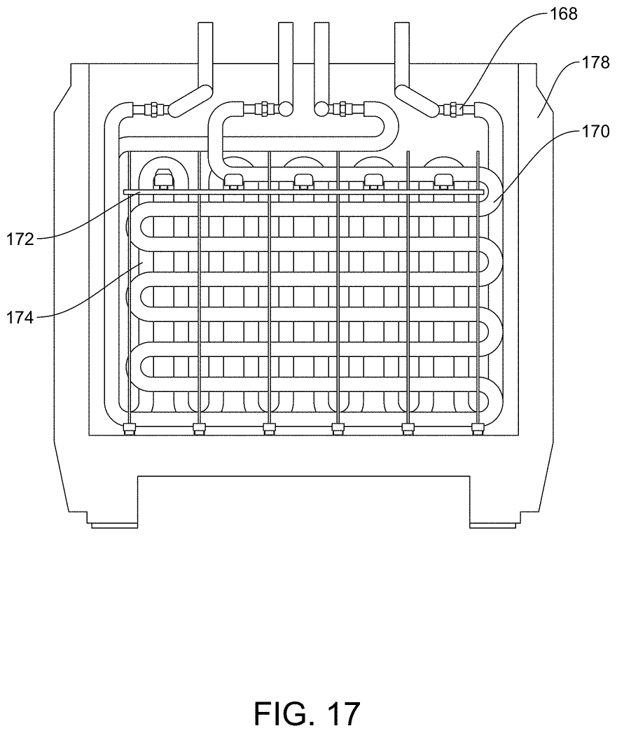

Preferred embodiment of the present invention can best be seen in FIGS. 14-17, where the thermal storage system is in the form of cubical structure that is filled with water or the like. As with previous embodiments, the horizontal tubing 174 is used to charge the system, that results in freezing of the water (creating ice). The vertical tubing 170 is then used to recover the energy by melting the ice (e.g., for air conditioning, etc.). This embodiment differs in several respects from the previous embodiments. First, copper fins (or the like) are used to provide a more efficient way to charge and recover energy.

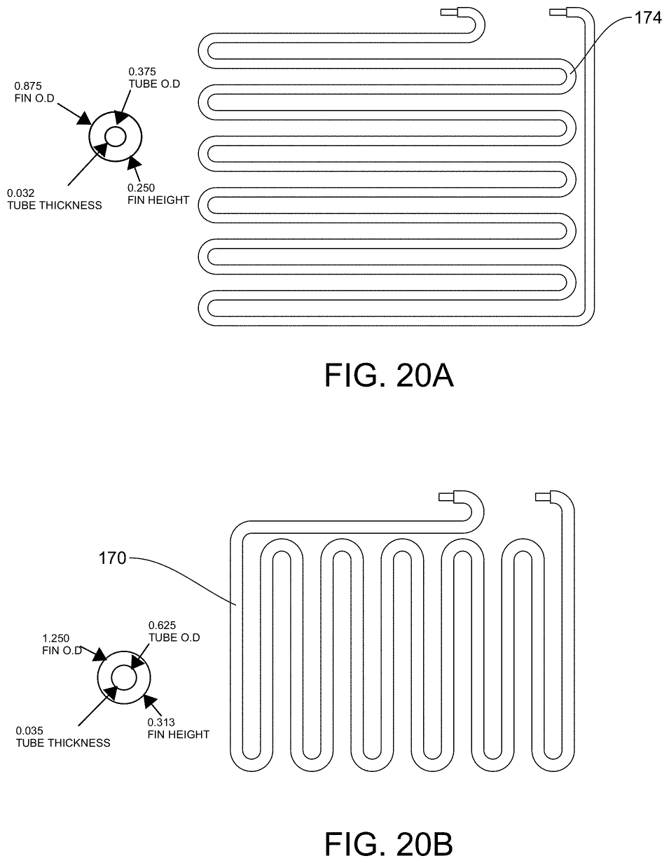

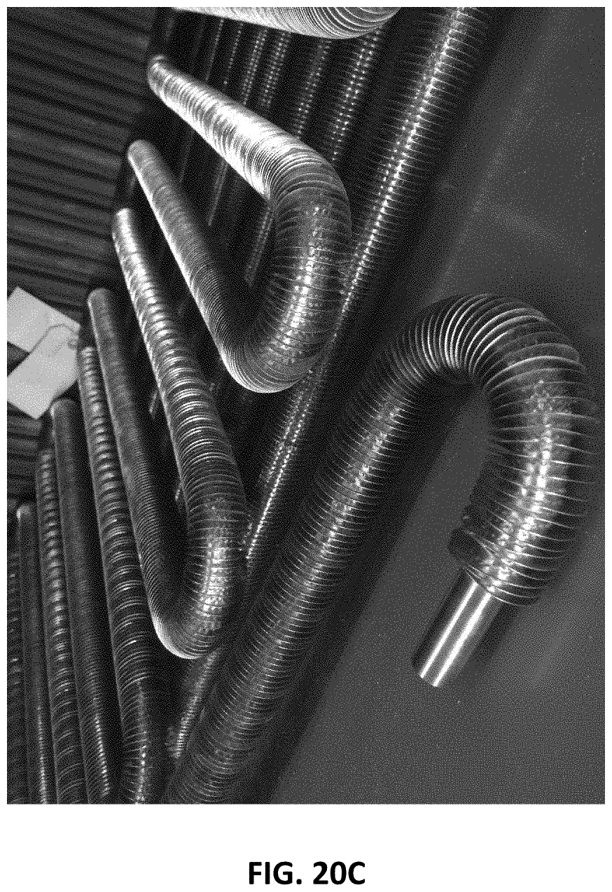

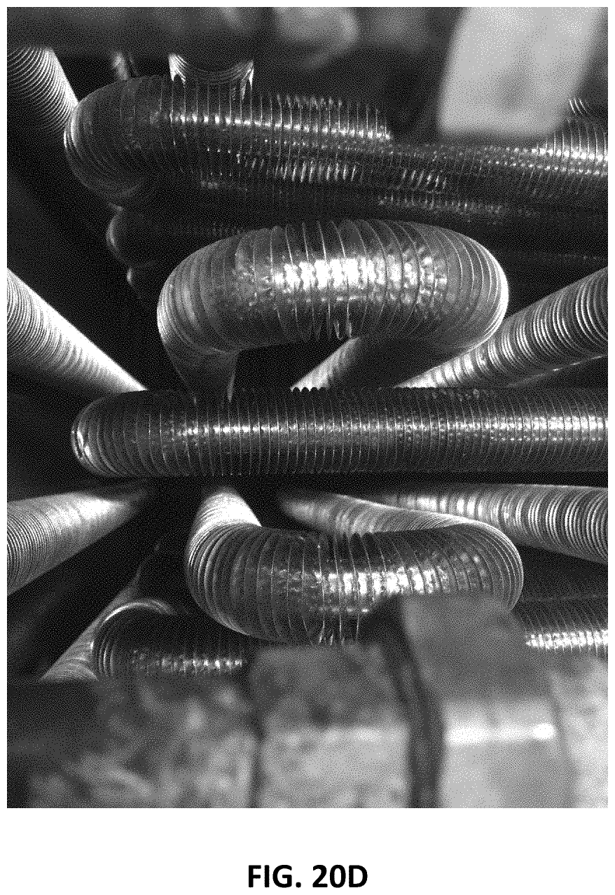

As before, horizontal and vertical tubing are alternately placed, thereby providing for better heat transfer. The tubing (170,174) is preferably made of copper and includes a plurality of fins (see, e.g., FIGS. 20C and D), which may be in the shape of circular rings protruding outward from and perpendicular to the tubing, to improve transfer of energy from inside to outside the tube (170,174). These circular rings can best be seen in FIGS. 20C and D, with preferred dimensions of the fins provided in FIGS. 20A and B. It should be appreciated however, that size, shape, and location of the fins are not limited to those shown in the figures, and other sizes, shape, and locations are within the spirit and scope of the present invention. With that being said, the inventor has discovered that construction and positioning of the fins as shown and described in the figures provide optimal heat transfer for the system.

As before, the tube (170,174) is bent to increase the length of the tubing in confined place. As best seen in FIG. 14, one or more ends of the legs of the horizontal tubing 174 and vertical tubing 170 can be bent to form a generally U-shaped (or alternatively V-shaped, Z-shaped, N-shaped, M-shaped, or W-shaped). The fins present on the tube are equally spaced to prevent contact with other fins of the tube. The tubing is properly spaced within the cube.

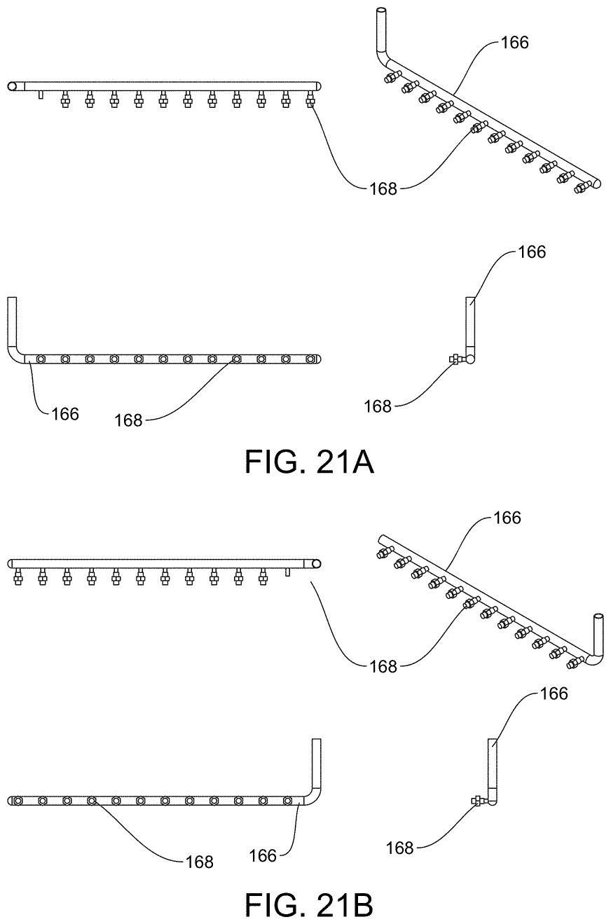

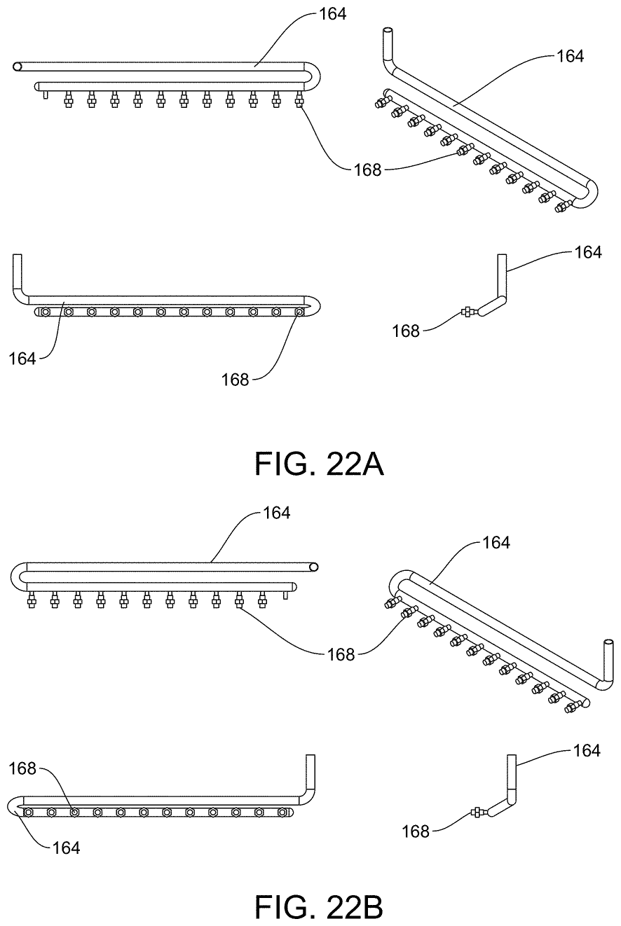

Each pair of bent tube has a first terminal end 168 and an adjacent second terminal end. Each first terminal end of each pair of bent tube is operably connected to an input charge manifold 166 (e.g., FIG. 21). The charge manifold 166 can be straight or U shape. Each second terminal end 168 of each pair of bent tube is operably connected to an output charge manifold 164 (e.g., FIG. 22). The input charge manifold 166 and output charge 164 manifold are preferably positioned adjacent or near to one another.

In another important embodiment, the present invention discloses that the housing 178 (cube (3D)) is charged from the bottom back to the upper front. And the order of discharging of the housing 178 (cube (3D)) is from upper front to the bottom back. The order of charging (bottom back to upper front) and discharging (rear left to front right) is deployed through the order in which the curtains (i.e., tubing or conduit) are connected to the manifolds. For example, to charge from the back forward, the curtain (or conduit) in the back should be connected to the first port on the charge manifold, the next (adjacent) curtain (or conduit) should be connected to the second port on the charge manifold, etc. The same is true for charging from the bottom upward, etc. It is through this order that results in the freezing of liquid from bottom back to upper front.

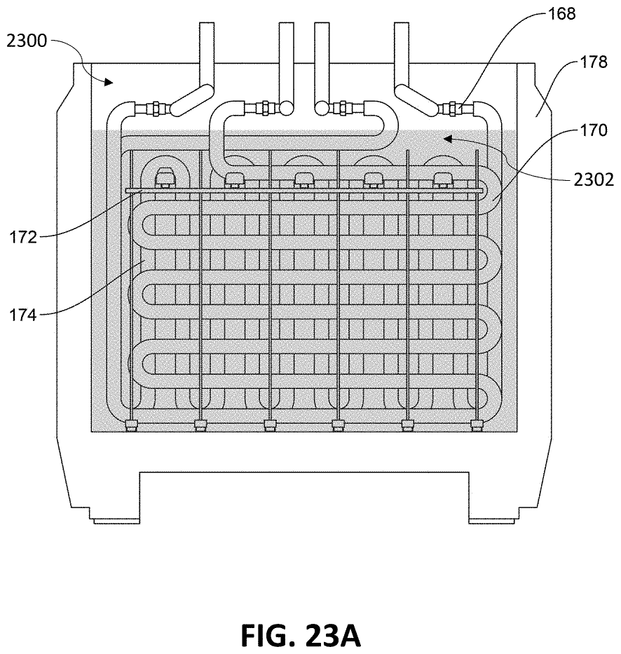

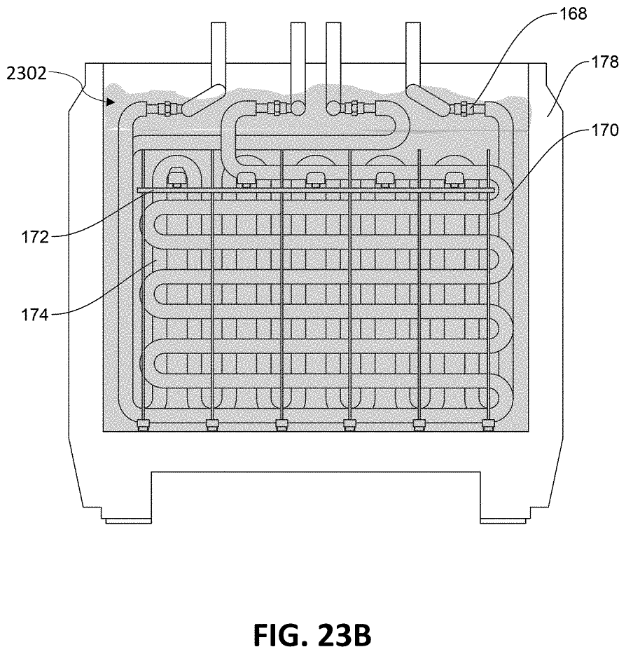

In one embodiment, water in a liquid phase (see, e.g., 2302 in FIG. 23A) is configured to cover the curtains (or a portion thereof) only, and not the manifolds, thereby providing an expansion space (i.e., air) (see, e.g., 2300 in FIG. 23A) at the top of the cube. This “expansion space” allows the water in a frozen/solid phase (i.e., ice) to expand upward, surround the manifold, similar to an iceberg (see, e.g., 2302 in FIG. 23B), when the water is charged (cooled) from the bottom back to the upper front. With that being said, it should be appreciated that the present invention is not limited to charging from bottom back to upper front and discharging in the reverse order. Other embodiments (e.g., from the bottom front to the top back, etc.) are within the spirit and scope of the present invention.

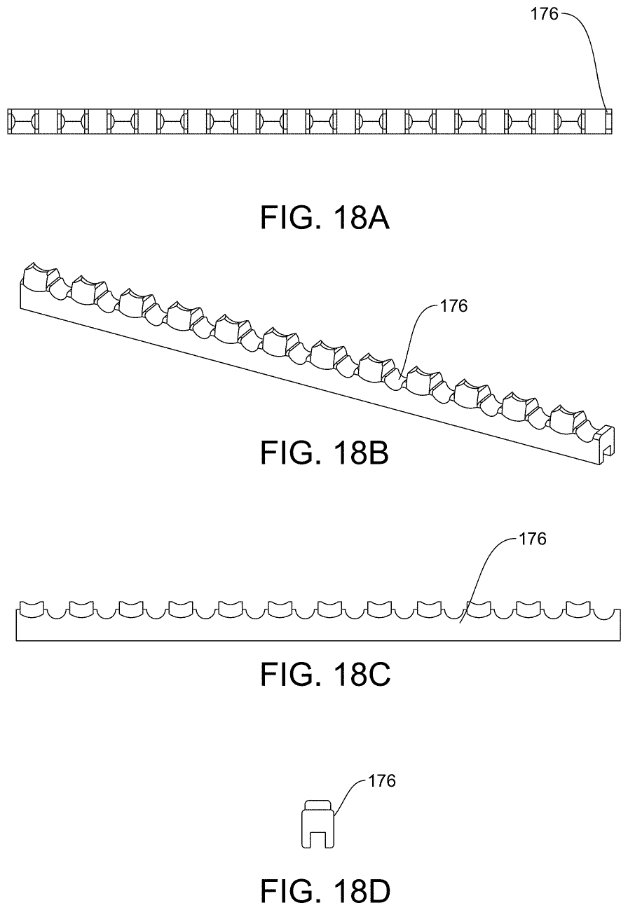

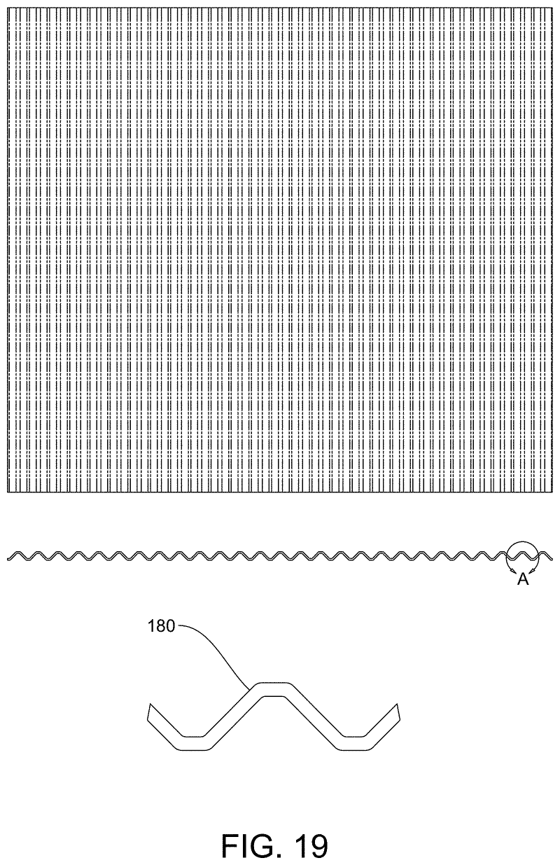

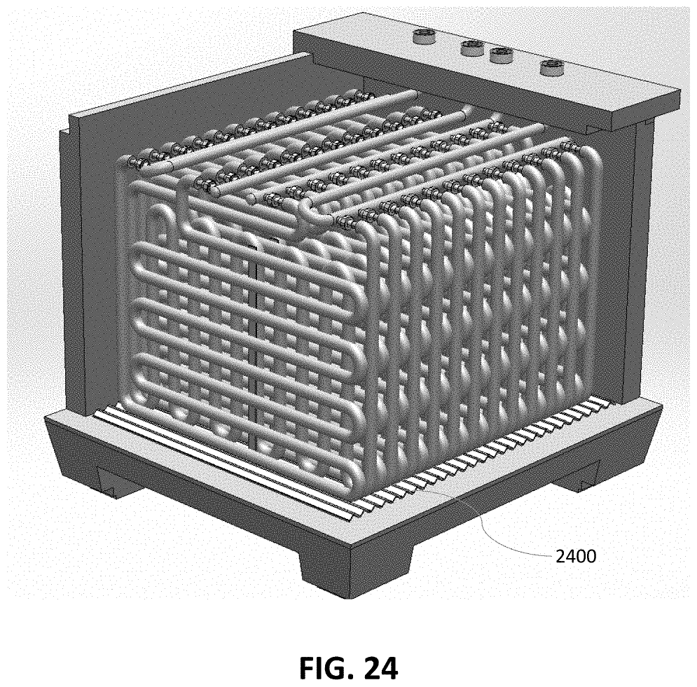

In an effort to ensure proper spacing between each curtain (or conduit), the system may further employ a continuous corrugated panel 180 (see, e.g., 180 in FIG. 19) positioned on the inside bottom of the cube (see, e.g., 2400 in FIG. 24), which provides proper spacing and security of the tubing within the cube 178. In addition, or alternatively, a plurality of corrugated panels 180 may be positioned on opposite sides of the cube (not shown), allowing each curtain (serpentine tubing) to be slide into a corresponding slot (from the top). In yet another embodiment, support rails (see, e.g., 176 in FIGS. 18A-D) may be placed between (or below) each curtain to ensure proper spacing (see, e.g., 176 in FIG. 14). The support rail 176 is generally manufactured from a relatively stiff material or metal.

FIG. 19 discloses a corrugated panel that can be positioned on the bottom (and in certain embodiments on opposing sides) of the cube 178. The corrugated panel is configured for proper spacing of the tubing within the cube 178. In certain embodiments, a plurality of corrugated panels 180 may also (or alternatively) be positioned on two sides of the cube 178, allowing each “curtain” (serpentine tubing) to be slide into a corresponding slot. The walls of corrugated panel 180 are formed in a zigzag manner as a “U” or “V” shape with surfaces at an angle of 90 degree to each other to provide optimal spacing between each curtain 172. The curtain wall configurations result in a series of repeated square “water or charging tunnels” (e.g., temperature charging tunnels) created horizontally through and by the combinations of alternating types of curtain walls formed at the end projections of the fins. Thus creates several regular intervals of repeated charge induction points continuously inducing a constant re-charge and intensification of the thermal waves coming from the specific curtain walls' serpentine loops and fins.

FIG. 20 discloses the copper tubing, which has a first terminal end 168 and an adjacent second terminal end 168. Each first terminal end of each pair of bent tube is operably connected to an input charge manifold 166. Each second terminal end of each pair of bent tube is operably connected to an output charge manifold 168. The input charge manifold 166 and output charge manifold 168 are preferably positioned adjacent or near to one another. The tubes are provided with circular fins on the surface to provide effective heat transfer. Dimensions of the fins are shown in FIGS. 20A and B, with actual photos of the fins shown in FIGS. 20C and D. The radiant energy coming from the fins directs and projects (radiates and conducts) the energy across the void through the water and piping cavity to the other unused adjacent piping creating a droid effect on that piping to engage its capacity for thermal conductance to specifically accelerate the phase-change processes.

FIGS. 21A-B and 22A-B disclose embodiments of the manifolds, including a straight charge manifold 166 and a straight recovery manifold 168, all positioned on the top of the cube 178. Other manifolds (e.g., U shape, etc.) are within the spirit and scope of the present invention. The cube 178 is then filled with a phase-changing material, e.g., water (or the like), and the gas/liquid within the horizontal tubing is used to charge the system, which freezes the phase-change material. The first connector on the charge manifold 166 is connected to the back, bottom curtain and so forth (the second connector is connected to the adjacent, similarly situated (horizontal) curtain and so forth). Thus, the freezing takes place from the bottom (back) upward toward the front. When liquid, the water should cover the curtains but not the manifolds, leaving an “expansion space” (e.g., around the manifolds). However, when frozen, the water will cover the manifold, like an iceberg. The vertical tubing 170 is used to recover the system, which melts the ice. The first connector on the recover manifold 168 connects to the rear, top curtain and proceeds forward (as with the charging system).

In prior embodiments, the interconnections between the manifolds and each tubing were fixed (e.g., were welded, etc.). However, in a preferred embodiment, the interconnections should be deployed using a plurality of fittings facilitating easy removal and replacement of an individual component in case of a mechanical failure of a component in the system.

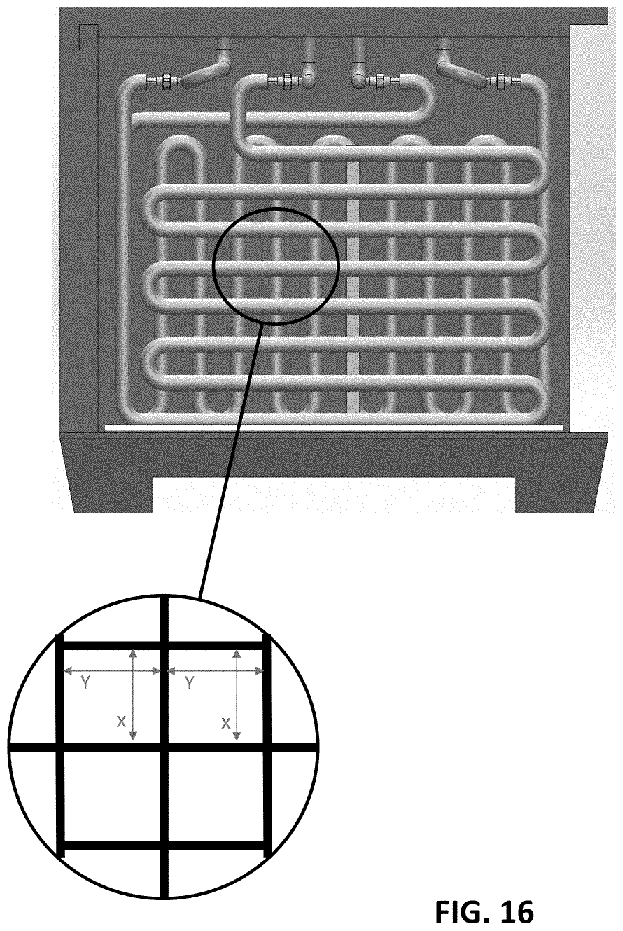

In other embodiments, not only are the charging (e.g., horizontal) curtains and the recovery (e.g., vertical) curtains properly space (as discussed above), but the checker-like waterways created by alternating between charging and recovery curtains (see, e.g., FIG. 16) should be uniform as well. For example, the height of each opening “Y” should be uniform, as should the width “X.” Furthermore, in a preferred embodiment, the height of each opening “Y” should also be substantially the same as the width of each opening “X.” It should be appreciated however, that the present invention is not limited such spacing and other spacings are within the spirit and scope of the present invention.

In sum, it should also be noted that it is often difficult and expensive to use the previously known refrigeration systems that utilize frozen blocks of ice, within multiple storied buildings. The reason for such difficulty and expense is that external circulation systems must be used. Furthermore, such external circulation systems must have a high-pressure capacity to permit their use within multiple storied buildings. Consequently, such external circulation systems require the purchase, installation, and operation of expensive and cumbersome external heat exchangers, circulating pumps, and additional controls and valves in order to circulate the refrigerant or fluid within the external system. In contrast, the present invention does not necessarily require the use of an external circulation system. Although an external circulation system could be used, if desired, it is not required. Consequently, most if not all of such additional elements and equipment are not needed within the present invention.

Furthermore, within the previously known systems, plastic pipes are used to both charge or freeze the ice and to discharge or melt the ice. The maximum operating pressure for such plastic piped systems is only ninety pounds per square inch (90 psi). Such a low-pressure capacity necessitates the use of an external circulation system. In contrast the heat exchangers of the present invention are preferably manufactured from copper. Copper has an internal working pressure capacity of about 300 pounds per square inch (300 psi) or higher. Consequently, the present invention is able to maintain a high-pressure rate within the internal flow of the second heat exchanger 26. This feature enables the present invention to be used within multiple storied buildings and other applications wherein high working pressures are required. Furthermore, the present invention does not require the use of an external circulation system.

The present invention imparts advantages over the existing arts by providing a relatively inexpensive and economical thermal storage system. The present invention is relatively simple to construct, assemble, and also extremely simple to use and is relatively inexpensive to operate. Furthermore, the invention is efficient, effective, functional, reliable, reusable, compact, rugged, and durable. It is important to note that the present invention permits the near immediate transition between charging and/or discharging of the system, without requiring a complete discharge or charge of the thermal reservoir between phase changes. Consequently, the thermal reservoir may be partially discharged and then recharged without having to completely discharge the system before recharging can occur. Similarly, the thermal reservoir may be partially recharged and then discharged without having to completely recharge the system before discharging can occur. Therefore, the present invention eliminates potential damage to the thermal storage and exchange system that otherwise often occurs for failure to completely discharge the system before the system is recharged. In addition, there is no need to completely recharge the system before the system is discharged. This advantage is important to allow continued use of the system to meet variable load demands without having to previously recharge the entire system.

The means and construction disclosed herein are by way of example and comprise primarily the preferred and alternative forms of putting the invention into effect. Although the drawings depict the preferred and alternative embodiments of the invention, other embodiments are described within the preceding text. One skilled in the art will appreciate that the disclosed apparatus may have a wide variety of sizes, shapes, and configurations. Additionally, persons skilled in the art to which the invention pertains might consider the foregoing teachings in making various modifications, other embodiments, and alternative forms of the invention.

Therefore, the foregoing is considered illustrative of only the principles of the invention. Further, since numerous modifications and changes will readily occur to those skilled in the art, it is not desired to limit the invention to the exact construction and operation shown and described, and accordingly, all suitable modifications and equivalents may be resorted to, falling within the scope of the invention. It is, therefore, to be understood that the invention is not limited to the particular embodiments or specific features shown herein. To the contrary, the inventor claims the invention in all of its forms, including all modifications, equivalents, and alternative embodiments which fall within the legitimate and valid scope of the appended claims, appropriately interpreted under the Doctrine of Equivalents.

1. An apparatus for causing a heat storage medium to pass between a liquid phase and a solid phase selectively and reversibly to charge or discharge a thermal reservoir, the heat storage medium defining the thermal reservoir, said apparatus capable of being supported by a support structure, said apparatus comprising a combination of:
a housing defining an enclosure, said housing capable of being supported by the support structure, said housing capable of containing the heat storage medium within said enclosure;
a plurality of charge manifolds and a plurality of recovery manifolds disposed within the housing;
a first heat exchanger having plurality of first conduits, the first heat exchanger being at least partially disposed within the housing, at least partially submerged within the heat storage medium, and having a refrigerant therein, the first heat exchanger capable of selectively decreasing temperature of the refrigerant below temperature of the heat storage medium, thereby reducing temperature of the heat storage medium within the enclosure; and
a second heat exchanger having plurality of second conduits, the second heat exchanger being at least partially disposed within the housing, at least partially submerged within the heat storage medium, and having a fluid therein, the second heat exchanger capable of selectively removing coolness from the heat storage medium within the enclosure;
wherein each one of the plurality of first and second conduits have a first terminal end and a second terminal end, wherein the first terminal end of each one of the plurality of first conduits is connected to a first one of the plurality of charge manifolds, the first terminal end of each one of the plurality of second conduits is connected to a second one of the plurality of charge manifolds, the second terminal end of each one of the plurality of first conduits is connected to a first one of the plurality of recovery manifolds, and the second terminal end of each one of the plurality of second conduits is connected to a second one of the plurality of recovery manifolds;
wherein each one of the plurality of first conduits is bent into a general serpentine configuration and includes a plurality of fins radiating outward, thereby improving the transfer of energy from the refrigerant inside the plurality of first conduits to the heat storage medium within the enclosure; and
wherein each one of the plurality of first conduits are connected to at least the first one of the plurality of charge manifolds in an order that allows the heat storage medium to cool from the bottom of the housing upward.

2. The apparatus of claim 1, wherein each one of the plurality of fins are circular and extend substantially perpendicular from a corresponding one of the plurality of first conduits.

3. The apparatus of claim 1, wherein the plurality of fins extend at least a length of a corresponding one of the plurality of first conduits that is submerged within the heat storage medium.

4. The apparatus of claim 1, further comprising a support rail to provide spacing between the plurality of first conduits and the plurality of second conduits, the support rail being located on a bottom of the housing.

5. The apparatus of claim 1, further comprising corrugated panels positioned on opposite sides of the housing, allowing at least each one of the plurality of first and second conduits to be slid into a corresponding slot.

6. The apparatus of claim 1, wherein each one of the plurality of first conduits are connected to the first one of the plurality of charge manifolds in an order that further allows the heat storage medium to cool from the back of the housing forward.

7. The apparatus of claim 1, wherein each one of the plurality of second conduits are connected to at least the second one of the plurality of recovery manifolds in an order that allows coolness to be removed from the heat storage medium in a controlled uniform direction.

8. The apparatus of claim 1, wherein interconnections between the plurality of charge and-the recovery manifolds to first and second conduits are deployed using a plurality of fittings facilitating easy removal and replacement of an individual component.

9-10. (canceled)

11. The apparatus of claim 1, wherein the housing further comprises a lid removably secured thereto.

12. The apparatus of claim 1, wherein the first heat exchanger comprises means for decreasing temperature of said refrigerant below temperature of the heat storage medium.

13. The apparatus of claim 1, wherein said second heat exchanger comprises means for increasing temperature of the fluid above temperature of the heat storage medium.

14. The apparatus of claim 1, wherein said heat storage medium is water, brine solution, or glycol solution.

15. An apparatus for causing a heat storage medium to pass between a liquid phase and a solid phase selectively and reversibly to charge or discharge a thermal reservoir, the heat storage medium defining the thermal reservoir, said apparatus comprising:
a housing defining an enclosure, said housing containing the heat storage medium;
plurality of charge manifolds and a plurality of recovery manifolds disposed within the housing;
a first heat exchanger having a plurality of first conduits, the first heat exchanger being at least partially disposed within the housing, at least partially submerged within the heat storage medium, and having a refrigerant therein, the first heat exchanger capable of selectively decreasing temperature of the refrigerant below temperature of the heat storage medium, thereby reducing temperature of the heat storage medium within the enclosure; and
a second heat exchanger having a plurality of second conduits, the second heat exchanger being at least partially disposed within the housing, at least partially submerged within the heat storage medium, and having a fluid therein, the second heat exchanger capable of selectively removing coolness from the heat storage medium within the enclosure;
wherein each one of the plurality of first conduits have a first terminal end connected to a first one of the plurality of charge manifolds and a second terminal end connected to a first one of the plurality of recovery manifolds, and each one of the plurality of second conduits have a first terminal end connected to a second one of the plurality of charge manifolds a second terminal end connected to a second one of the plurality of recovery manifolds; and
wherein each one of the plurality of first and second conduits is bent into a general serpentine configuration and includes a plurality of fins radiating outward, thereby improving the transfer of energy to and from the heat storage medium; and
wherein the plurality of first conduits are connected to at least the first one of the plurality of charge manifolds in an order that allows the heat storage medium to cool from the bottom of the housing upward.

16. The apparatus of claim 15, further comprising a support rail on the bottom of the housing to provide spacing between the plurality of first and second conduits.

17. The apparatus of claim 15, further comprising corrugated panels positioned on opposite sides of the housing, allowing each one of the plurality of first and second conduits to be slid into a corresponding slot.

18. The apparatus of claim 16, further comprising corrugated panels positioned on opposite sides of the housing, allowing each one of the plurality of first and second conduits to be slid into a corresponding slot.

19. The apparatus of claim 15, wherein the plurality of first conduits are connected to at least the first one of the plurality of charge manifolds in an order that, further allows the heat storage medium to cool from the back of the housing forward.

20. The apparatus of claim 15, wherein the plurality of second conduits are connected to at least the second one of the plurality of recovery manifolds in an order that allows coolness to be removed from the heat storage medium from the right of the housing to the left.
